(19) United States
(12) Patent Application Publication
(10) Pub. No.: US 2026/0307587 A1
(43) Pub. Date: Oct. 8, 2026

(54) VEHICLE CAMERA ASSEMBLY

(71) Applicant: Valeo Comfort and Driving Assistance, Creteil (FR)

(72) Inventors: Yingfan HOU, Troy, MI (US); Jakub HAVRANEK, Creteil (FR); Jiri KOVALIK, Creteil (FR)

(21) Appl. No.: 19/170,370

(22) Filed: Apr. 4, 2025

(51) Int. Cl. B60R 1/04; H04N 23/51; H04N 23/52; H04N 23/57; B60R 11/00

(52) U.S. Cl. CPC B60R 1/04; H04N 23/51; H04N 23/52; H04N 23/57; B60R 2011/0028; B60R 2011/0059

(57) ABSTRACT

A vehicle camera assembly designed for integration into an overhead console (OHC) addresses challenges of secure fixation and thermal management. The assembly includes a front cover with parallel flanges for stable mounting, a camera lens, and a rear cover with an integrated heat sink featuring fins that engage a bracket in a face-to-face relationship. This configuration promotes balanced force distribution and effective heat dissipation, enhancing camera stability and performance. The assembly provides positional flexibility to accommodate various vehicle models. Additionally, a pigtail connector integrated into the rear cover ensures secure electrical connections. This innovative design simplifies installation, reduces component complexity, and improves thermal management, making the assembly suitable for enhancing driver assistance and safety features in modern vehicles.

### TECHNICAL FIELD

The present disclosure relates to vehicle camera systems. More specifically, in embodiments, this disclosure focuses on the mounting and thermal management of camera assemblies within a vehicle’s overhead console, for example.

### BACKGROUND

In modern vehicles, the integration of camera systems within the overhead console is becoming increasingly prevalent, driven by the demand for enhanced safety and driver assistance features. These systems require precise mounting solutions to ensure stability and optimal functionality. However, existing methods for installing cameras in this area often face challenges related to secure fixation, thermal management, and positional flexibility. Traditional designs may involve multiple components that complicate the assembly process and can lead to issues such as undesirable movement of the camera or inadequate heat dissipation.

Current solutions often separate the functions of positioning and fixation, which can result in increased complexity and potential for misalignment. Additionally, effective thermal management is of great importance, as inadequate heat dissipation can affect the performance and longevity of the camera system. These limitations highlight the need for a more integrated and efficient approach to mounting camera systems within vehicle overhead consoles, addressing both mechanical stability and thermal performance while accommodating variations in vehicle models.

### SUMMARY

In an embodiment, a camera assembly for attaching a camera to an overhead console (OHC) of a vehicle comprises: a front cover having a first flange and a second flange, wherein the first flange defines a first mounting surface configured to mount to an external component, and wherein the second flange defines a second mounting surface configured to mount to an external component, wherein the first and second mounting surfaces extend within parallel planes; a camera lens; and a rear cover connected to the front cover to define an opening therebetween that contains the camera lens and associated electronics, wherein the rear cover includes a heat sink comprising a plurality of fins, wherein the fins define engagement surfaces configured to engage a bracket in the OHC in a face-to-face relationship, wherein the engagement surfaces are parallel to the first and second mounting surfaces

In an embodiment, a camera assembly for attaching a camera to an overhead console (OHC) of a vehicle comprises: a front cover having a flange that defines a mounting surface configured to mount to an external component of the OHC; a camera lens; and a rear cover with an integrated heat sink, wherein the rear cover is connected to the front cover to define an opening therebetween that contains the camera lens and associated electronics, wherein the integrated heat sink includes a plurality of fins that define engagement surfaces configured to engage a bracket in the OHC in a face-to-face relationship, wherein the engagement surfaces are parallel to the first and second mounting surfaces.

In an embodiment, a camera housing for an overhead console (OHC) of a vehicle comprises: a front cover; a printed circuit board assembly (PCBA) having a PCBA connector; a rear cover attached to the front cover to house the PCBA, wherein the rear cover is formed with an opening aligned with the PCBA connector; and a pigtail connector configured to connect cables to the PCBA, wherein the pigtail connector comprises an outer cap having a clip configured to flex radially inward, wherein the clip passes through the opening of the rear cover and is supported by the rear cover while a pin of the pigtail connector is connected to the PCBA connector.

### BRIEF DESCRIPTION OF THE DRAWINGS

FIG. 1 is a front perspective view of a camera assembly connected to a bracket for integration into a vehicle’s overhead console, according to an embodiment.

FIG. 2 is a rear perspective view of the camera assembly of FIG. 1.

FIG. 3 is an exploded view illustrating the components of the camera assembly, according to an embodiment.

FIG. 4 is a rear perspective view of the camera assembly of FIG. 1, similar to FIG. 2, with the bracket removed from view, according to an embodiment.

FIG. 5 is a bottom perspective view of the camera assembly of FIG. 1.

FIG. 6 is a side view of the camera assembly of FIG. 1 with the bracket removed from view, according to an embodiment.

FIG. 7 is a front perspective view of a camera assembly according to a second embodiment.

FIG. 8 is a rear perspective view of the rear cover of the camera assembly according to an embodiment.

FIG. 9 is a front perspective view of the rear cover of FIG. 8 with a cable attached, according to an embodiment.

FIG. 10 is an enlarged view of a portion of FIG. 9 showing the connection between the cable and the rear cover.

FIG. 11 is a cross-sectional view of a connector for connecting the cable directly to a PCBA via the rear cover, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the automotive industry, the integration of advanced camera systems into vehicles has become increasingly prevalent, particularly for enhancing driver assistance and safety features. One common location for mounting such cameras is within the vehicle’s overhead console (OHC). However, the installation of cameras in this position presents several challenges, primarily related to secure fixation, thermal management, and maintaining positional stability during vehicle operation.

Existing solutions for mounting cameras in the OHC often involve complex assemblies that require multiple components, such as separate brackets and heat sinks. These assemblies can be cumbersome to install and may not provide adequate thermal dissipation, leading to potential overheating of the camera electronics. Additionally, the reliance on multiple components can result in increased manufacturing costs and assembly time. Furthermore, many current designs do not offer sufficient flexibility for adjusting the camera’s position to accommodate different vehicle models, which can lead to misalignment and suboptimal camera performance.

The present disclosure addresses these challenges by providing a novel camera assembly designed for secure attachment to the OHC of a vehicle. This assembly features a front cover with two flanges that offer parallel mounting surfaces, ensuring stable positioning. The rear cover incorporates a heat sink with fins that engage a bracket in a face-to-face relationship, effectively balancing the forces applied to the flanges of the front cover. This configuration not only secures the camera in place but also allows for flexibility in adjusting the camera’s position in the X and Y directions, accommodating various vehicle models. Additionally, the integration of the heat sink into the rear cover enhances thermal dissipation, providing a significant improvement over existing solutions that typically separate the bracket and heat sink functions. This innovative approach ensures optimal thermal management and positional flexibility, distinguishing this system from existing technologies.

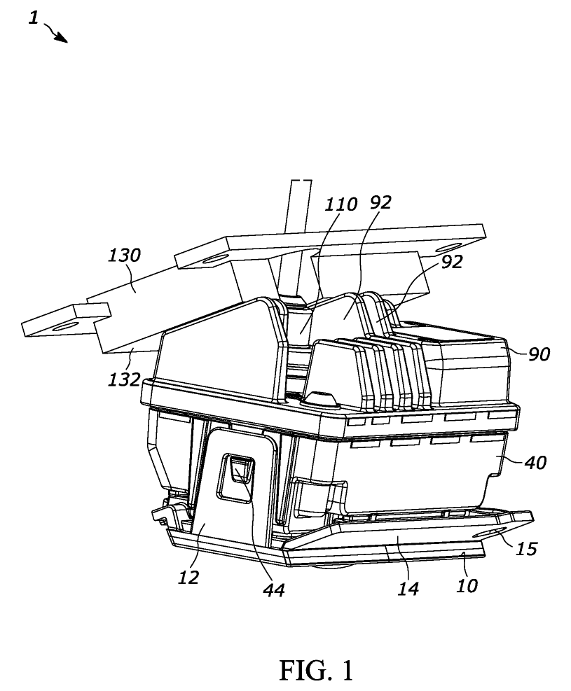

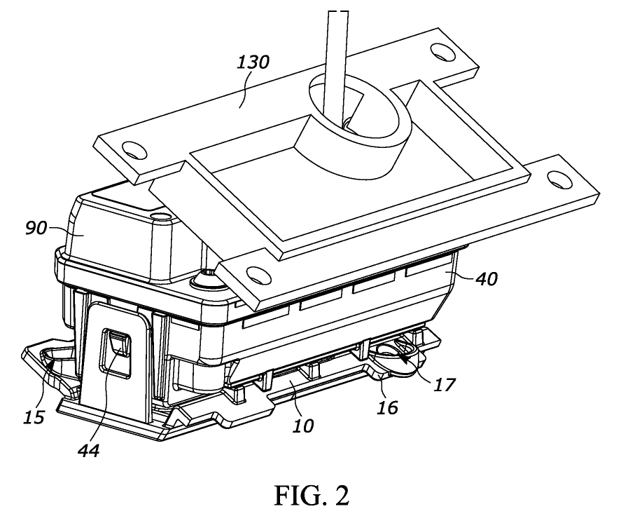

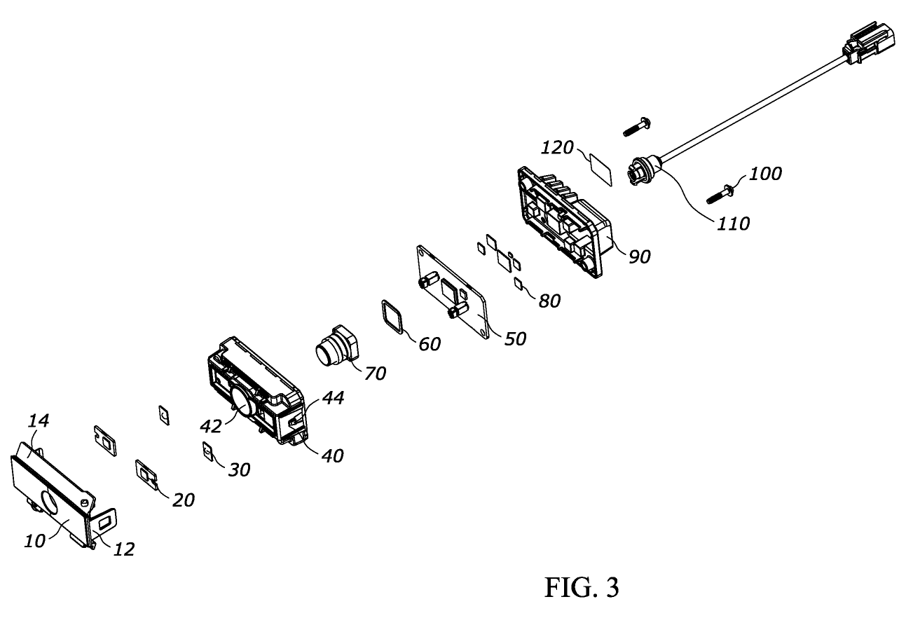

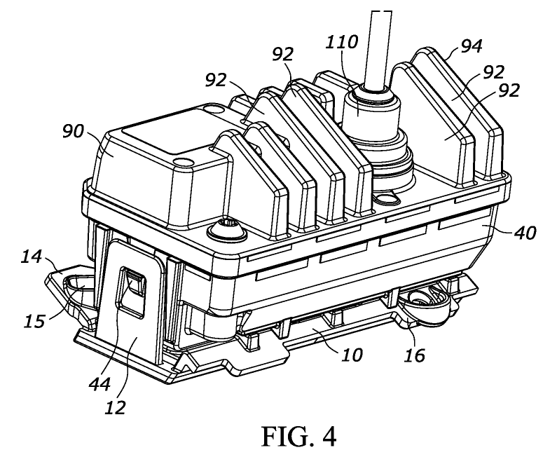

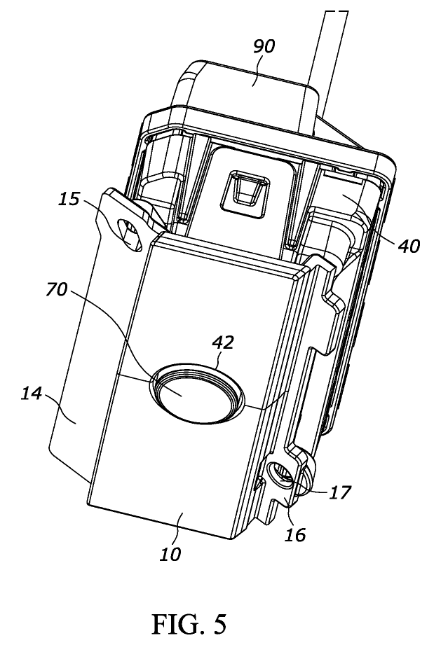

Turning now to the Figures, FIGS. 1-2 illustrate a camera assembly 1 configured to attach to an OHC of the vehicle via a bracket 130. The camera assembly 1 is shown in an exploded view in FIG. 3, and is shown assembled without the bracket 130 in FIGS. 4-6. Referring to the exploded view shown in FIG. 3, the camera assembly 1 includes an LED cover (also referred to as a front cover) 10, LED printed circuit boards (PCBs) 20, thermal gel 30, a housing 40 which connects to the LED cover 10, a PCB assembly (PCBA) 50, glue 60, a camera lens 70, thermal gel 80, a rear cover with heat sink 90, fasteners 100 (e.g., screws) for securing various components together, a pigtail connector 110 , and a label 120.

Referring to FIGS. 1-6, the LED cover 10 serves as a primary interface for aligning and securing the camera assembly within the vehicle’s OHC. It features two openings (e.g., first aperture 15 and second aperture 17) that align with positioning pins in the OHC, ensuring precise placement. The LED cover 10 also includes two flanges, the first flange 14 and the second flange 16, which provide parallel mounting surfaces. In other words, the first flange 14 and the second flange 16 are parallel to one another, or at least a lower (outer) engagement surface of the flange are parallel to one another. These flanges support the camera assembly and maintain stability. The LED cover 10 allows for some flexibility in the X and Y directions while ensuring the camera remains fixed in the Z direction. The first aperture 15 is located on the first flange 14, and the second aperture 17 is provided on the second flange 16. These two apertures 15, 17 can be provided on opposite corners of the LED cover 10 for proper positioning in the vehicle OHC, and more apertures may be provided for additional security in the attachment.

The LED cover 10 includes a tab 12 that is designed to facilitate secure attachment of the cover to the housing 40. Namely, the tab 12 has an opening that is configured to engage with tab 44 of the housing 40 for a snap-fit connection between the two. Various forms of tabs, protrusions, locks, or the like can be provided to secure the LED cover to the housing 40, and the illustrated tabs 12, 44 are merely one embodiment.

The LED PCBs 20 provide the required circuitry for the operation of the LED components. These PCBs are mounted within the housing 40 and are connected to the camera’s power and control systems. The LED PCBs 20 are designed to withstand the thermal and mechanical stresses associated with vehicle operation, ensuring reliable performance over the camera’s lifespan.

The thermal gel 30 is applied to the LED PCBs 20 to enhance thermal management within the camera assembly. This material facilitates the efficient transfer of heat away from the PCBs, preventing overheating and ensuring optimal performance. The application of thermal gel 30 aids in maintaining the longevity and reliability of the camera’s electronic components, as the gel helps to dissipate heat generated during operation.

The housing 40 functions as a primary structural component of the camera assembly, enclosing and protecting the internal components, including the LED PCBs 20, the PCBA 50, and the camera lens 70. The design of the housing 40 ensures a robust and durable enclosure capable of withstanding the environmental conditions encountered in a vehicle’s OHC. Additionally, the housing 40 features an opening 42 for the camera lens 70, permitting unobstructed image capture while preserving the integrity of the assembly. The opening 42 is sized and configured to receive the camera lens 70.

The PCBA 50 is the printed circuit board assembly that houses the camera’s electronic components, including the image sensor and processing circuitry. This assembly is mounted within the housing 40 and is connected to the LED PCBs 20 and other components via electrical connectors. The PCBA 50 is designed to provide reliable performance under the thermal and mechanical stresses encountered in a vehicle environment.

The glue 60 is used to secure various components within the camera assembly, ensuring the components remain in place during operation. This adhesive is chosen for its capacity to endure the thermal and mechanical stresses linked to vehicle operation, offering a durable bond that preserves the assembly’s integrity.

The camera lens 70 is responsible for capturing images and transmitting them to the image sensor on the PCBA 50. The lens is designed to provide high-quality image capture under a range of lighting conditions, ensuring the camera can perform effectively in various environments. The camera lens 70 is mounted within the housing 40, with the opening 42 providing a clear path for image capture. The image sensor can be an RGB camera, but can also be an infrared image sensor, RADAR sensor, LiDAR sensor, or the like. References to a "camera" herein are not intended to be limited to just an RGB camera, but can include other types of image sensors that are provided in vehicle settings.

The thermal gel 80 is applied to the rear cover 90 to improve thermal management within the camera assembly. This material aids in the efficient transfer of heat away from the rear cover 90, preventing overheating and ensuring optimal performance. The thermal gel 80 maintains the longevity and reliability of the camera’s electronic components, as it helps to dissipate heat generated during operation.

The rear cover with heat sink 90 provides both structural support and thermal management. The rear cover 90 is connected to the housing 40 (e.g., via fasteners 100) so as to enclose the camera’s internal components, protecting them from environmental factors while also facilitating heat dissipation. The heat sink, integrated into the rear cover 90, features a plurality of fins 92 that increase the surface area for heat exchange, enhancing the assembly’s ability to dissipate heat generated during operation.

The fins 92 are designed to engage with the bracket 130 in a face-to-face relationship, ensuring efficient thermal transfer and mechanical stability. In particular, the upper surfaces 94 of the fins 92 can be sloped, angled or tapered so that they match flush with the lower surface 132 of the bracket 130. As such, the upper surfaces 94 of the fins 92 can be referred to as engagement surfaces of the fins, and the lower surface 132 of the bracket 130 can be referred to as an engagement surface of the bracket. These engagement surfaces 94, 132 can be angled or oriented such that they extend in a parallel planes that mate upon engagement.

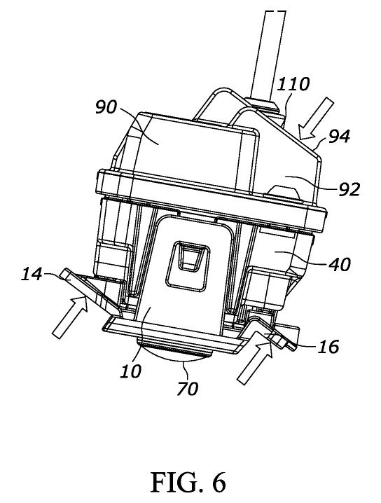

The upper surfaces 94 of the fins 92 are also oriented parallel to the mounting surfaces of the flanges 14 and 16. This ensures a balanced force distribution and minimizes the risk of movement during operation. For example, referring to FIG. 6 in particular, a force applied by the bracket’s engagement surface 132 to the fin’s engagement surfaces 94 is represented by arrow 140. Likewise, a force applied to the first flange 14 is represented by arrow 142, and a force applied to the second flange 16 is represented by arrow 144. Forces 142, 144 can be applied by the vehicle’s OHC structure, headliner, or other surface within the vehicle. Due to the parallel orientation of the engagement surface 94 with the engagement surfaces of the flanges 14, 16, the force 140 applied to the fins 92 extends in an opposite (i.e., 180-degree) direction as the force 142, 144 applied to the flanges 14, 16. This ensures a balanced force distribution applied to the camera assembly 1, which helps maintain the camera in a desired orientation with a reduced risk of forces causing the camera to become misaligned.

Rounding out the components shown in FIG. 3, the pigtail connector 110 establishes electrical connections between the camera assembly and the vehicle’s electrical system. This connector is designed to provide a secure and reliable interface, ensuring consistent power and data transmission. The pigtail connector 110 is mounted on the rear cover 90, with clips providing additional fixation to maintain electrical contact and prevent disconnection during operation. The label 120 is used to provide identification and technical information about the camera assembly. This label is typically affixed to the rear cover 90 and includes details such as the model number, serial number, and other relevant specifications.

Referring to FIGS. 1-6, the front cover 10 and flanges 14, 16 can be constructed from a lightweight metal alloy to enhance durability and thermal management. The rear cover 90 may feature fins 92 with varying thickness or spacing to optimize heat dissipation based on the specific heat output of the camera’s electronics. The bracket 130 can be adjustable or interchangeable to accommodate different vehicle models, providing flexibility in the camera assembly’s application. Additionally, the camera lens 70 can be equipped with different focal lengths or apertures to suit specific imaging requirements, such as wide-angle lenses for broader field-of-view applications.

In another embodiment, the camera assembly 1 can integrate the bracket 130 directly into the rear cover 90, eliminating the need for a separate component. This design would facilitate the assembly process and reduce potential friction noise between the rear cover and bracket. The fins 92 can be designed to directly interface with the vehicle’s overhead console, providing a robust fixation method and enhancing thermal dissipation.

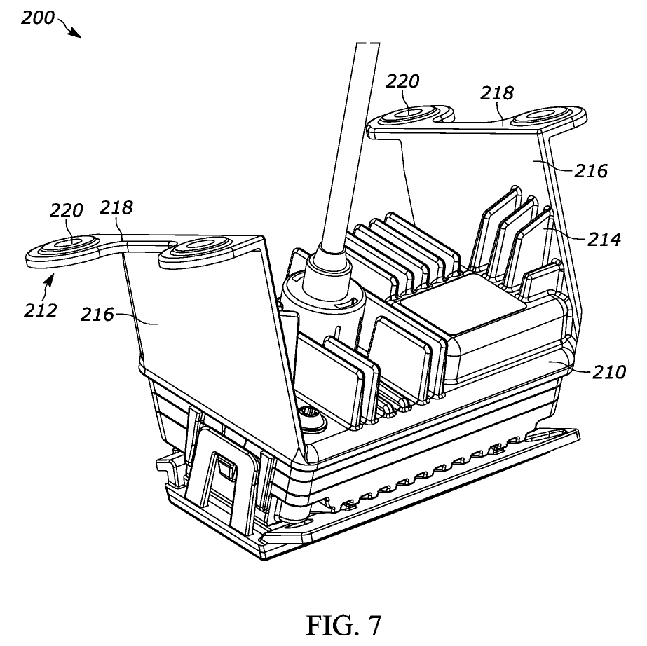

On that note, FIG. 7 illustrates a camera assembly 200 according to a second embodiment. The camera assembly 200 includes similar components as the first embodiment, except that the rear cover differs in this embodiment. In particular, the camera assembly 200 includes a rear cover 210 with an integrated bracket 212. The integrated bracket 212 extends from the rear cover 210 and together are a unitary, monolithic piece. This allows for the removal of the bracket 130 of the first embodiment, allowing the camera assembly 200 to attach directly to the OHC, such as an OHC housing. Fins 214 extend from the rear cover 210, but are not in direct face-to-face engagement with any part of the OHC, and thus need not be shaped or angled to match such a surface.

In the illustrated embodiment, the integrated bracket 212 includes two walls 216 that flank either side of the rear cover 210. These walls provide structural support and stability to the camera assembly. Each wall 216 ends at a corresponding engagement surface 218. The engagement surfaces 218 can be flat and angled for appropriate connection to the OHC. Also, each engagement surface 218 can include fastener apertures 220 for receiving fasteners to connect the bracket 212 to the OHC.

This embodiment can yield benefits such as a reduction in potential friction noise between separate components, as the integrated design minimizes contact points. The removal of parts (e.g., bracket 130) yields a reduction in material, weight, and cost. The monolithic structure also enhances thermal dissipation, as the fins 214 extending from the rear cover 210 are not in direct face-to-face engagement with any part of the OHC, allowing for more efficient heat exchange with the surrounding air. Additionally, the integrated design provides a more robust fixation method, enhancing the durability and reliability of the camera assembly in various vehicle environments.

Referring to FIGS. 1-6, there also remains a need for a reliable and secure method to fix the cables 131 to the camera assembly, ensuring consistent electrical contact and maintaining a certain pull-out force. Traditional methods of connecting cables directly to the PCBA board can lead to issues with cable stability and electrical connectivity, especially when the cable passes through the mechanical housing.

Therefore, according to embodiments disclosed herein, the pigtail cable connector 110 is integrated directly into the rear cover 90 of the camera assembly 1. This design allows the cable 131 to be clipped securely to the rear cover 90, preventing rotation and maintaining a strong electrical connection. As will be described, the use of a plastic cap, metal ferrule, and sealing components ensures that the cable is well-fixed and provides a robust sealing mechanism. This approach not only enhances the pull-out force of the cable but also simplifies the assembly process by eliminating the need for additional components to block the cable position. The design ensures that the cable assembly can be performed from the outside of the rear case, improving ease of installation and maintenance.

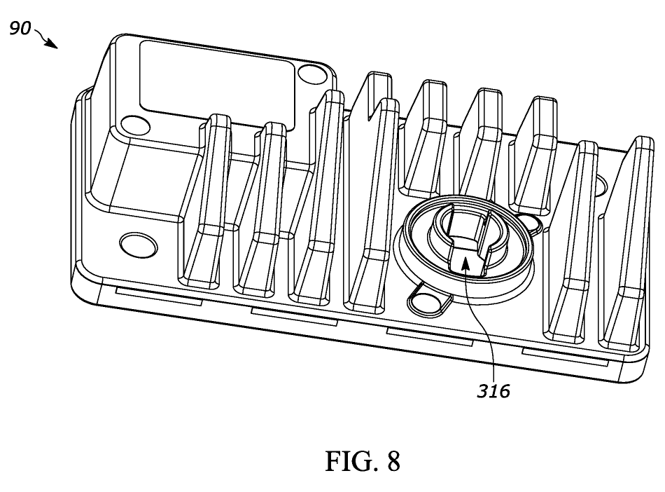

FIGS. 8-11 illustrate a pigtail connector 300 according to an embodiment. This embodiment addresses the challenge of securely connecting cables to the camera’s printed circuit board assembly (PCBA) while maintaining a robust electrical connection and ensuring ease of assembly. The pigtail connector 300 is configured to connect the cables 131 to a corresponding connector 304 of the PCBA 50 that is housed within the rear cover 90. To do so, the pigtail connector 300 has a flexible cap (e.g., made of plastic) 302 that engages with the rear cover 90 while allowing a corresponding pin 318 to engage the connector 304 of the PCBA 50. The cables 131 are routed through the plastic cap. The engagement between the cap 302 and the rear cover 90 ensures that the cable is held firmly in place, preventing unwanted movement or disconnect.

The rear cover 90 can include fins 92, engagement surfaces 94, and the like that were described above with reference to FIGS. 1-7.

A seal 306 is positioned around the cable 131, providing a barrier against environmental factors such as moisture and dust. This seal works in conjunction with a ferrule 308, which adds mechanical stability and ensures that the cable remains securely attached to the connector 304. An O-ring 310 is included in the assembly, between a ledge of the cap 302 and an outer surface of the rear cover 90, to enhance the sealing capability, further protecting the internal components from external contaminants. When the cap 302 is connected to the rear cover 90, the seal 306 and O-ring 310 are compressed or deformed slightly to provide the seal.

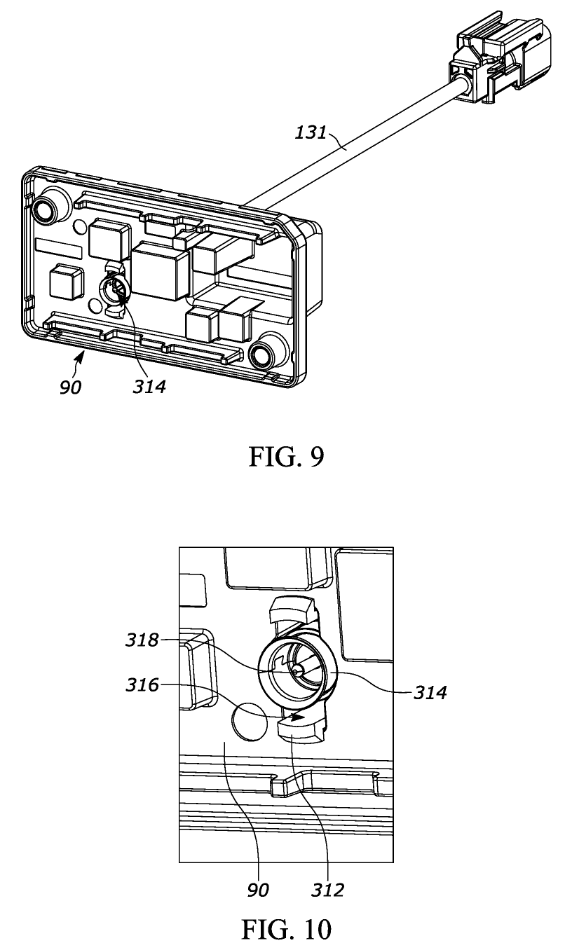

To aid in the connection between the cap 302 and the rear cover 90, the cap 302 can be provided with a pair of clips 312, which can also be referred to as elongate fingers. The clips 312 are configured to bend or flex radially inward, and are biased to return to the position shown in FIGS. 8-11. To assemble the cap 302 to the rear cover 90, a user can simply press the clips 312 into an opening 316 in the rear cover 90. The opening 316 can be a rectangular shape, thereby preventing rotation of the cap 302 with respect to the rear cover. The opening 316 can be keyed to match the profile of the cap 302. With the clips 312 fully inserted through the opening 316, a ledge can rest against a rear side of the rear cap 302, as shown in FIGS. 9-10 that prevents the cap 302 from being withdrawn or removed from the rear cover 90.

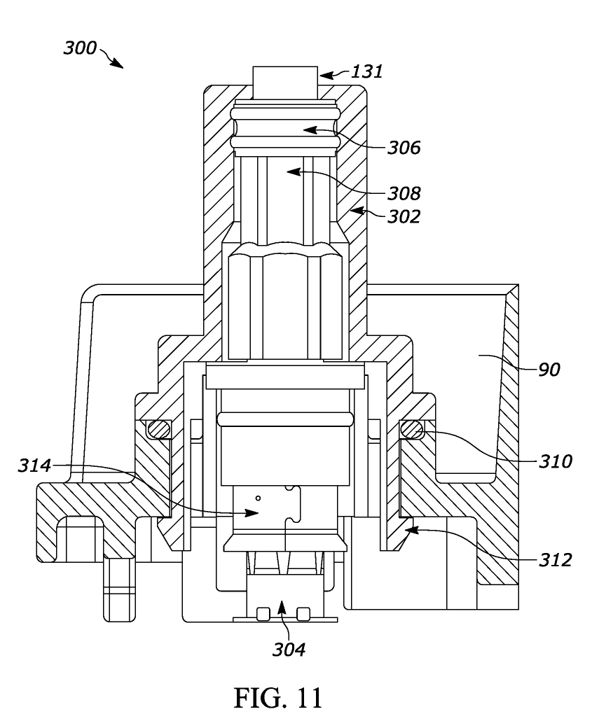

The opening 316 in the rear cover 90 is aligned with a corresponding connector on the PCBA 50. Thus, when the cap 302 is attached to the rear cover 90, a pin 318 of the pigtail connector is connected to connector 304 of the PCBA 50. This electrically and communicatively connects the cables 131 to the PCBA 50. A pin shield 314 surrounds the pin 318 and can mate or surround the connector 304, as shown in FIG. 11.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A camera assembly for attaching a camera to an overhead console (OHC) of a vehicle, the camera assembly comprising:
a front cover having a first flange and a second flange, wherein the first flange defines a first mounting surface configured to mount to an external component, and wherein the second flange defines a second mounting surface configured to mount to an external component, wherein the first and second mounting surfaces extend within parallel planes;
a camera lens; and
a rear cover connected to the front cover to define an opening therebetween that contains the camera lens and associated electronics, wherein the rear cover includes a heat sink comprising a plurality of fins, wherein the fins define engagement surfaces configured to engage a bracket in the OHC in a face-to-face relationship, wherein the engagement surfaces are parallel to the first and second mounting surfaces.

2. The camera assembly of claim 1, wherein the engagement surfaces being parallel to the first and second mounting surfaces enable forces applied to the rear cover from the bracket to exert in a direction opposite to forces applied to the first and second mounting surfaces.

3. The camera assembly of claim 1, wherein the engagement surfaces directly contact a surface of the bracket in the OHC.

4. The camera assembly of claim 1, wherein the engagement surfaces extend in a common plane that is parallel to the surface of the bracket in the OHC.

5. The camera assembly of claim 1, further comprising a camera housing disposed between the front cover and the rear cover, wherein the front cover has a pair of tabs with openings and the camera housing has a corresponding pair of tabs that engage with the openings to secure the camera housing to the front cover.

6. The camera assembly of claim 1, wherein the engagement surfaces extend in a common plane, and wherein the heat sink comprises additional fins that do not intersect the common plane.

7. A camera assembly for attaching a camera to an overhead console (OHC) of a vehicle, the camera assembly comprising:
a front cover having a flange that defines a mounting surface configured to mount to an external component of the OHC;
a camera lens; and
a rear cover with an integrated heat sink, wherein the rear cover is connected to the front cover to define an opening therebetween that contains the camera lens and associated electronics, wherein the integrated heat sink includes a plurality of fins that define engagement surfaces configured to engage a bracket in the OHC in a face-to-face relationship, wherein the engagement surfaces are parallel to the first and second mounting surfaces.

8. The camera assembly of claim 7, wherein the engagement surfaces extend along a common plane.

9. The camera assembly of claim 8, wherein the common plane is parallel to a surface of the bracket that directly contacts the engagement surfaces.

10. The camera assembly of claim 7, wherein the integrated heat sink is a monolithic, unitary component with the rear cover.

11. The camera assembly of claim 7, wherein the front cover has a second flange that defines a second mounting surface that is parallel to the mounting surface and the engagement surfaces.

12. The camera assembly of claim 7, wherein the engagement surfaces being parallel to the mounting surface enable forces applied to the rear cover from the bracket to exert in a direction opposite to forces applied to the mounting surface.

13. The camera assembly of claim 7, wherein the engagement surfaces directly contact a surface of the bracket in the OHC.

14. The camera assembly of claim 7, further comprising a camera housing assembled to the front cover with a snap-fit in which tabs engage with corresponding openings.

15. The camera assembly of claim 7, wherein the engagement surfaces extend in a common plane, and wherein the heat sink comprises additional fins that do not intersect the common plane.

16. A camera housing for an overhead console (OHC) of a vehicle, the camera housing comprising:
a front cover;
a printed circuit board assembly (PCBA) having a PCBA connector;
a rear cover attached to the front cover to house the PCBA, wherein the rear cover is formed with an opening aligned with the PCBA connector; and
a pigtail connector configured to connect cables to the PCBA, wherein the pigtail connector comprises an outer cap having a clip configured to flex radially inward, wherein the clip passes through the opening of the rear cover and is supported by the rear cover while a pin of the pigtail connector is connected to the PCBA connector.

17. The camera housing of claim 16, wherein the clip is biased to flex radially outward such that a ledge of the clip is engaged with an outer surface of the rear cover.

18. The camera housing of claim 16, wherein the opening in the rear cover facilitates alignment between the pigtail connector and the PCBA connector.

19. The camera housing of claim 16, further comprising an O-ring on an outer surface for the clip, and a seal ring on an inner surface of the clip.

20. The camera housing of claim 16, wherein the front cover has first and second flanges defining parallel mounting surfaces configured to mount to an external component, wherein the rear cover includes a heat sink comprising a plurality of fins, wherein the fins define engagement surfaces configured to engage a bracket in the OHC in a face-to-face relationship, and wherein the engagement surfaces are parallel to the mounting surfaces of the first and second flanges.
